(19) United States
(12) Patent Application Publication
(10) Pub. No.: US 2006/0106644 A1
(43) Pub. Date: May 18, 2006

(54) Patient referral and physician-to-physician marketing method and system

(76) Inventors: Charles C. Koo, Palo Alto, CA (US); Ming L. Chien, Cupertino, CA (US); Daniel F. Lam, Cupertino, CA (US)

Correspondence Address: SQUIRE, SANDERS & DEMPSEY L.L.P, 600 HANSEN WAY, PALO ALTO, CA, 94304-1043, US

(21) Appl. No.: 09/871,325

(22) Filed: May 30, 2001

(51) Int. Cl. G06F 19/00

(52) U.S. Cl. 705/3; 715/507

(57) ABSTRACT

A method and apparatus are provided for creating a referral network for member physicians utilizing the Internet. The referral network provides its members an organized and efficient system for generating and storing patient referrals. To become a member of the referral network, a physician registers with the referral network web site. A member physician generates a patient referral document using referral network software on the referral network web site. The patient referral document is sent to another physician to refer a patient to the physician. If the recipient physician is not a member of the referral network, the patient referral document includes a promotion for the referral network to induce the physician receiving the referral document to become a member of the referral network.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCE TO CD-ROM APPENDIX AND APPENDIX A

An Appendix A containing a computer program listing is submitted on a compact disk, which is herein incorporated by reference in its entirety. The total number of compact discs including duplicates is two. Appendix A, which is part of the present specification, also contains a list of the files contained on the compact disk.

### BACKGROUND OF THE INVENTION

1. Field of the Invention

The disclosure relates to physician referrals and communication between physicians about patient medical conditions. In particular, the disclosure relates to streamlining the referral and medical record keeping process, and creating an organized physician referral network.

2. Background

When a physician refers a patient to a second physician, the referral can be communicated in a number of ways. The patient may simply tell the second physician, when making an appointment with the second physician, that s/he is being referred from the first physician. The second physician may or may not follow up with the first physician to check if the referral was actually made. Often, the first physician sends by mail or fax a referral letter to the second physician to introduce the patient and request the services of the second physician, especially if the second physician is known to be difficult to make an appointment with unless by referral.

There can be varying levels of communication about the patient's condition between the first and second physician regarding the patient's condition. If no referral letter is written, it may be up to the patient to re-communicate his or her complaint to the second physician. In this case, if the second physician wants to know the full details of the patient's condition, a complete reexamination, including tests, may be necessary. This can be costly, and still may not provide all of the information that can be found in the patient's medical history, e.g. drug allergies. If a referral letter was sent, the first physician may or may not have included all relevant information on the patient's medical condition in a referral letter to the second physician. Physicians are extremely pressed for time, especially in the current health-care system, and time spent writing a referral letter is time spent away from patients. The second physician may or may not keep the first physician informed of the patient's condition, for example, by copying to the first physician test results or the diagnosis, again because of the time and extra expense involved. The problem can be compounded when several physicians are involved in treating the same patient.

Such haphazard communication and record keeping can be inconvenient, costly, and even dangerous to the patient's welfare. If the physician treating the patient is not fully aware of the patient's history, problems which range from relatively harmless, e.g., repeating tests which have already been run, to quite dangerous, e.g. pursuing a course of treatment that conflicts with another course of treatment in a life-threatening manner, may result.

Accordingly, the present inventors have determined that what is needed is a method of quickly and efficiently referring a patient to a physician while including all relevant medical information with the referral. A streamlined and organized referral method would also allow rapid and easy communication between physicians about a patient's condition and create an accurate record, easily accessed by each physician, of the treatments and conditions of the patients under their care.

Such a system would likely be of great benefit for physicians that are not associated with a large clinic or hospital, since these physicians are the most likely to see patients from a variety unaffiliated physicians, and therefore encounter varying levels of thoroughness in communication and record keeping. Making these physicians aware of the existence of an organized referral and medical records management system, however, could involve a costly advertising campaign. These physicians may also be skeptical of such a system without seeing it in practice. Therefore what is also needed is a simple, cost-effective method for introducing such a system to physicians and allowing the physicians to see the system in practice for the purposes of promoting the effectiveness of the system.

### SUMMARY

A method and apparatus are provided for creating a referral network for member physicians and for using the referral letters generated by the referral network to market the network itself and associated products from physician to physician. The referral network provides its members an organized and efficient system for generating and storing patient referrals. To become a member of the referral network, a physician registers with the referral network. A member physician generates a patient referral document and sends the patient referral document to another physician to refer a patient to the physician. The patient referral document includes a promotion for the referral network and induces the physician receiving the referral document to become a member of the referral network.

In one embodiment the patient referral document includes a patient referral letter and a cover sheet. The patient referral letter includes the physician's contact information, the patient's contact information, and information about the patient's medical condition from the patient's medical records. The cover sheet contains the promotion for the referral network. The referral document can be faxed or mailed to the recipient physician.

The referral letter can be generated from a database of patient medical records, patient contact information, and physician contact information. Using a computer program, the user, for instance the member physician, selects the patient medical information to be included in the referral letter from the patient medical records database and the patient and physician contact information from their respective databases. The user also chooses a letter template. The computer program inserts the selected information into the letter template to create a complete letter. The computer program also generates a cover letter, which includes a promotional announcement to be sent with the referral letter.

A server computer hosts a web site for the referral network. Member physicians have an account on the server computer and can access the web site through a global-area network. The server computer has an associated database of referral letters sent to the web site by member physicians to allow other member physicians to view the referral letters.

In one embodiment, a member physician accesses the referral network using a clinic computer, which communicates with the referral network server computer through a global-area network. The clinic computer executes medical records management software and is connected to a clinic data storage system storing a database of patient contact information and patient medical information. The computer program executed by the server computer is able to access patient contact and medical information stored in the databases on the clinic data storage system, and transmit that information to the data storage system associated with the server computer. The medical records management software also facilitates the generation of electronic patient medical information for storage in the clinic data storage system.

### BRIEF DESCRIPTION OF THE FIGURES

FIG. 1 is an illustration of the primary components of the present referral network system.

FIG. 2 is a block diagram illustrating a referral letter being communicated to a clinic that is a member of the referral network system.

FIG. 3 is a block diagram illustrating a referral letter being communicated to a clinic that is not a member of the referral network system.

FIG. 4 is an example of a cover sheet that would accompany a referral letter being communicated to a clinic that is not a member of the referral network system.

FIG. 5 is an example of a “welcome” page generated with the referral network software and for use with the referral network system.

FIG. 6 is an example of a page in the “Compose” module of the referral network software for selecting patient and physician contact information to be included in the referral letter.

FIG. 7 is an example of a page generated by the referral network software used to add or change patient contact information stored in the patient contact information database.

FIG. 8A is an exampJe of a page in the “Compose” module which is used to confirm the selected patient and physician contact information, access draft letters in progress for the selected patient and physician, and access chart notes containing medical information for the selected patient.

FIG. 8B is an example of a page in the “Compose” module used to select a chart note from the patient medical information database.

FIGS. 8C and 8D are an example of a chart note from the patient medical information database.

FIGS. 9A and 9B are an example of a page in the “Compose” module in which information from the patient's medical records is selected for inclusion in the referral letter.

FIG. 10 is an example of a template referral letter used with the referral network software.

FIGS. 11A and 11B are an example of a referral letter generated by the referral network software.

FIG. 12 is an example of a page in the “Compose” module that allows the user to edit the text of the referral letter in free form.

### DETAILED DESCRIPTION

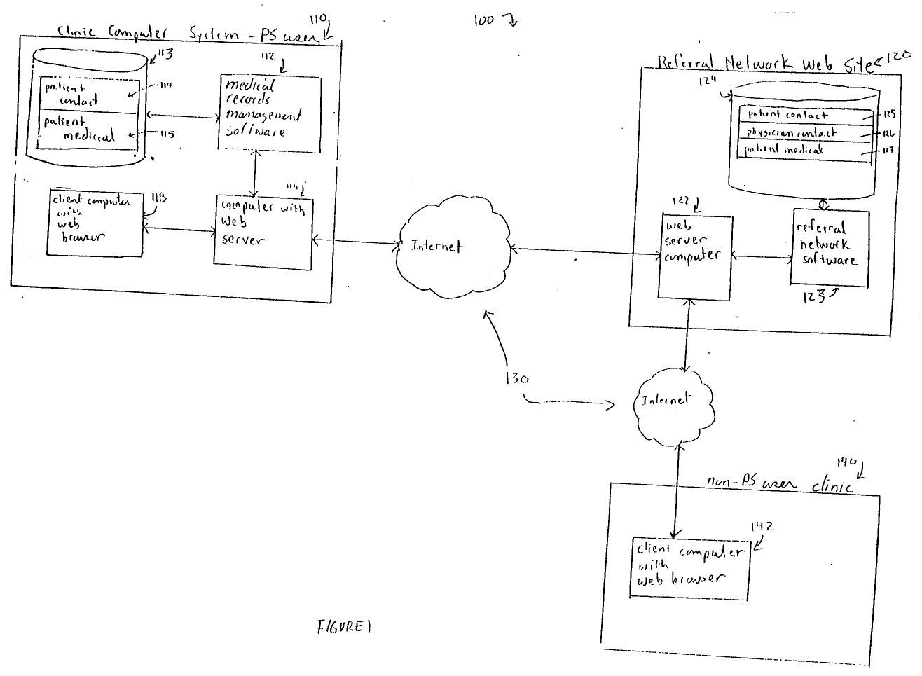

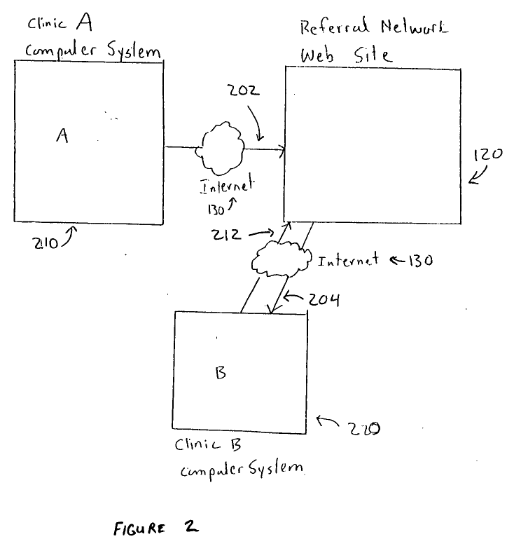

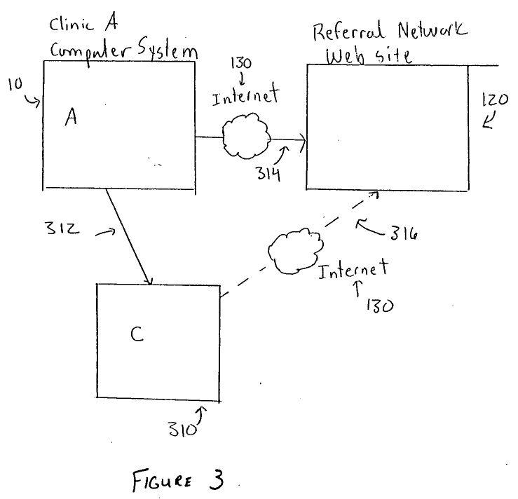

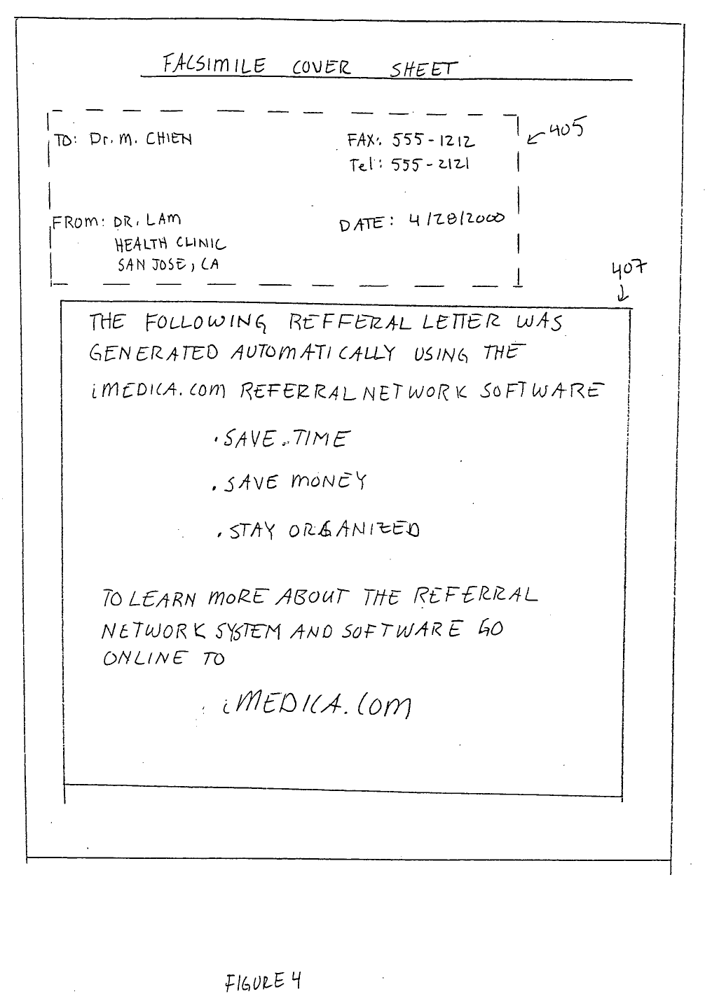

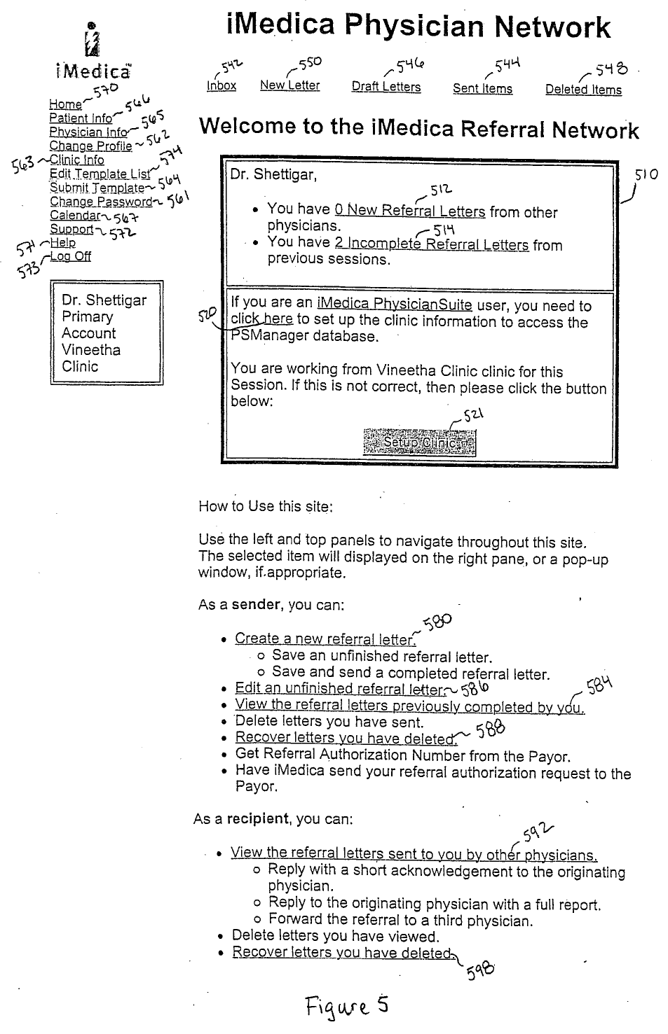

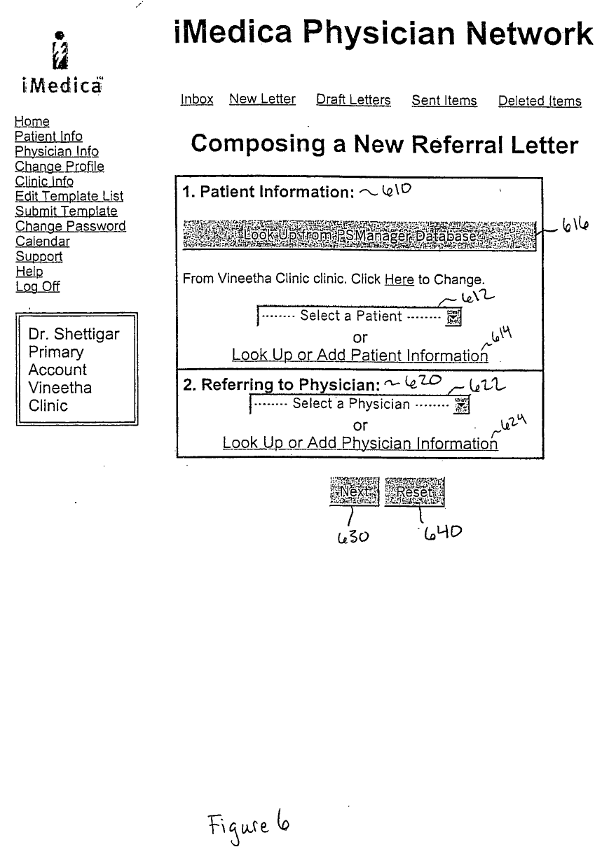

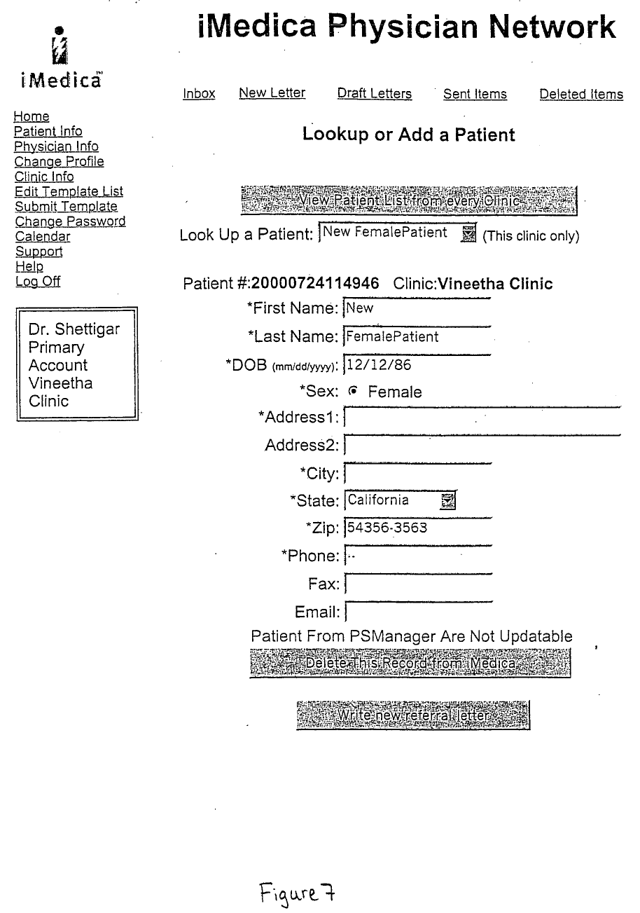

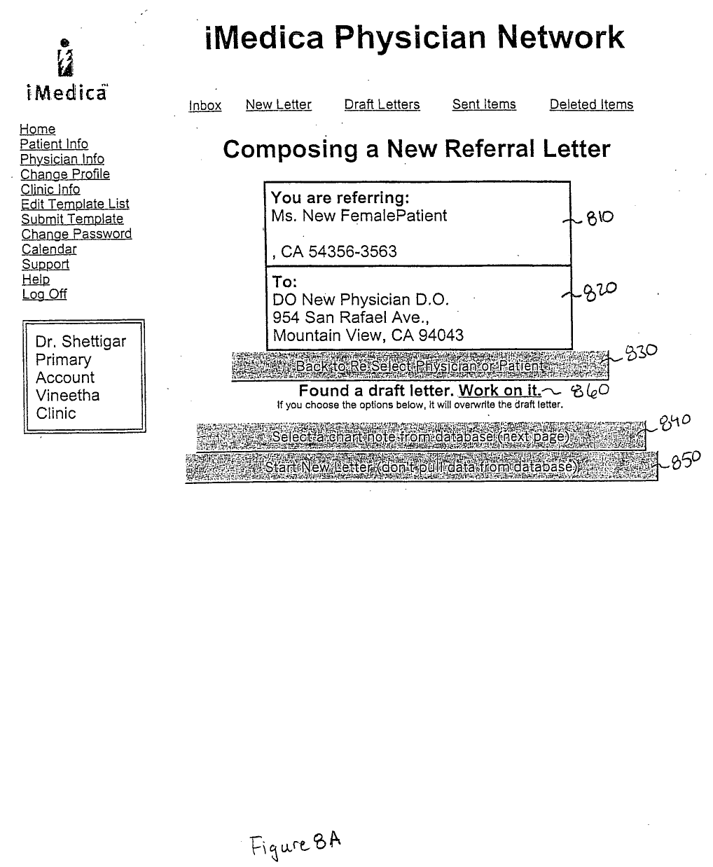

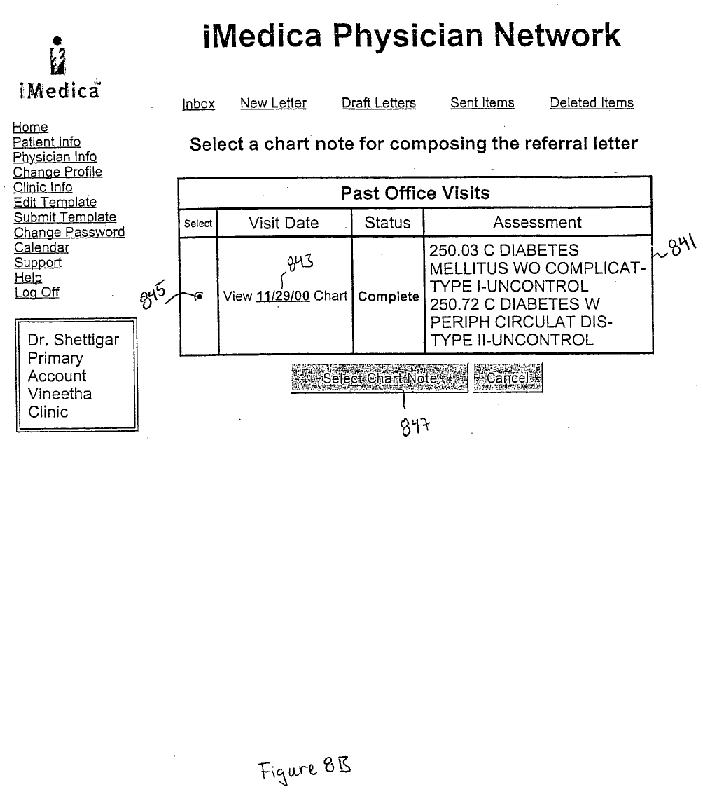

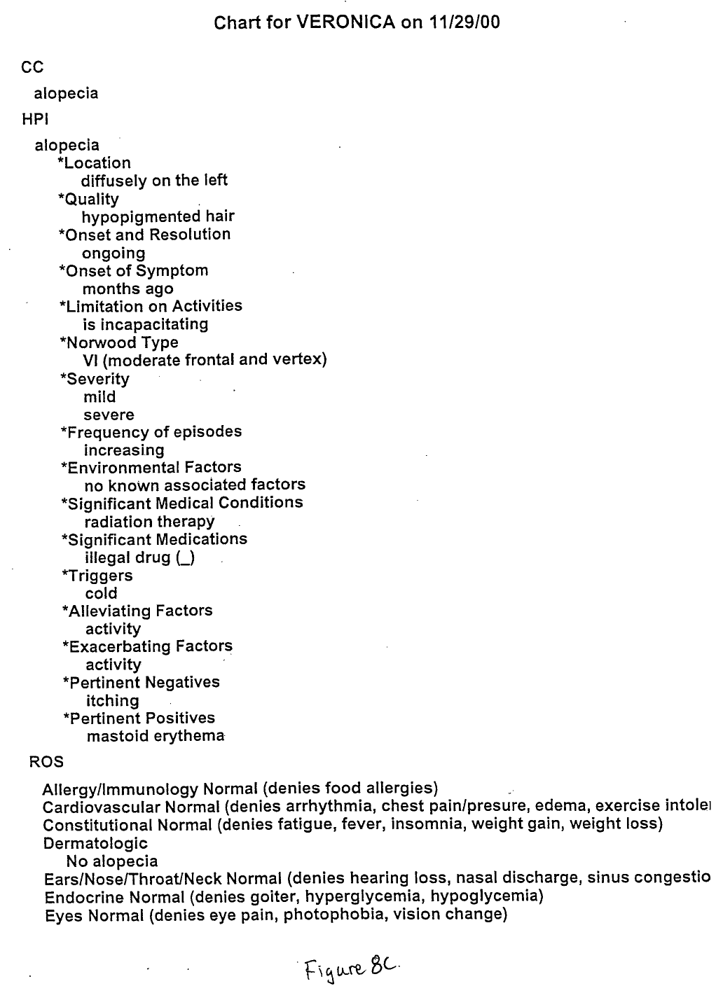

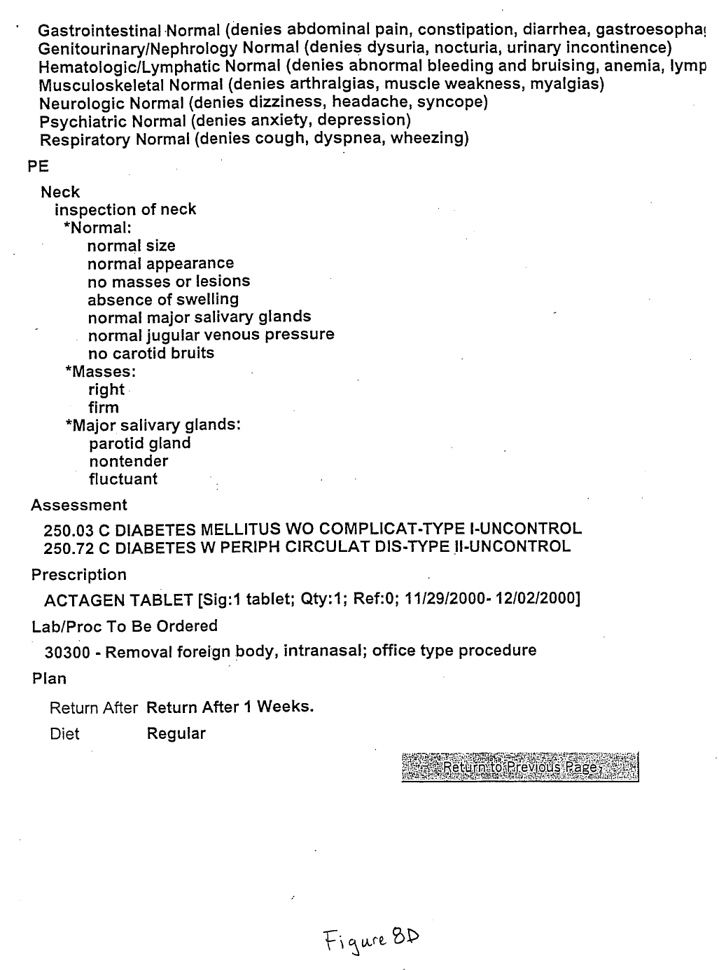

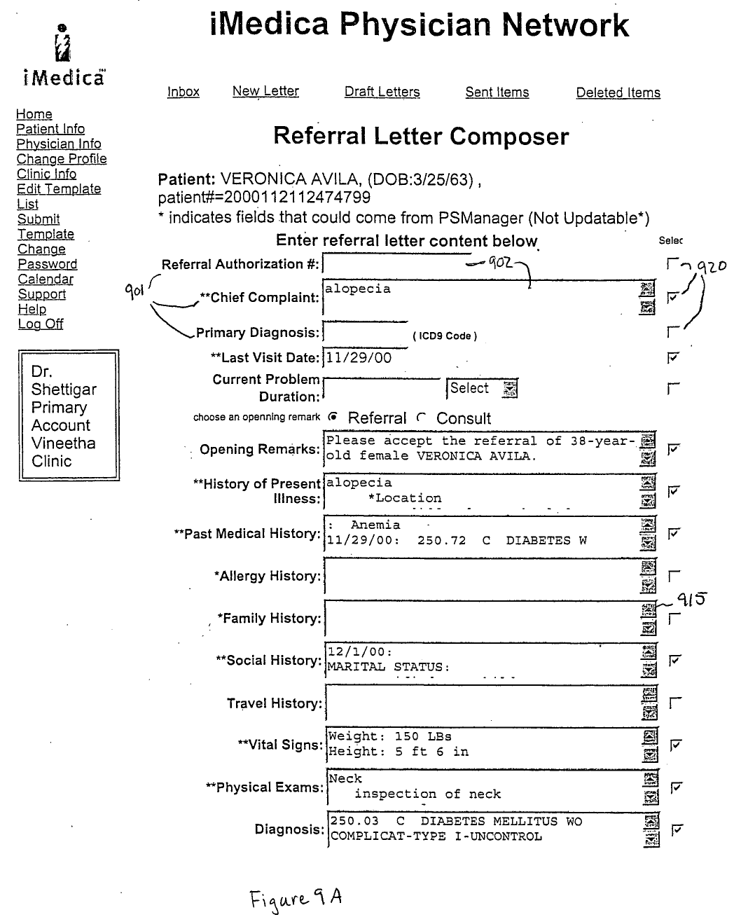

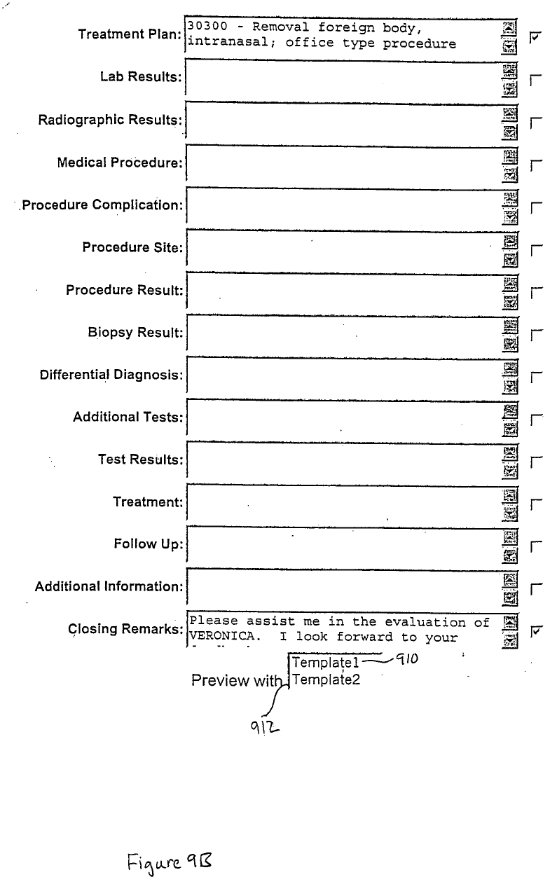

The structure of a computer system suitable for the present referral network system 100 is illustrated in FIG. 1. The computer system operates in the context of conventional client-server relationships used in global-area networks, e.g., the Internet, as is well known in the computer field and described in U.S. Pat. No. 6,029,141, incorporated herein by reference.

The referral network web site 120 includes conventional web server computer 122, referral network software 123, and computer readable data storage system (memory) 124. The data storage system 124 stores a conventionally organized database of patient contact information 125 and a conventionally organized database of physician contact information 126, for physicians both sending and receiving the referral letters. The data storage system 124 also stores the contents of referral letters that have been sent, that are in the process of being drafted, and that have been received by the physicians, in a conventionally organized database of patient medical records 127. Referral network software 123 contains letter templates and computer code used with the information in the databases 125, 126, and 127 to generate patient referral documents. A suitable computer for web site computer 122 would be a Pentium II or Pentium III (from Intel) based personal computer using MicroSoft Corporation's NT Server 4.0 operating system with service pack 3 and using IIS 4.0. A suitable database program would be MicroSoft Corporation's SQL server 7.0.

In one embodiment, the referral network web site is accessed by clients at two types of clinics—clinics that use medical records management software associated with the referral network to manage internal clinic records, and clinics that do not. As used herein, the term “clinic” refers to any physician office, hospital, or medical facility where patients are examined by and/or seek treatment from physicians, dentists, or other health-care professionals. The terms “physician” and “health-care professional” includes veterinarians (whose patients are animals).

The first type of clinic, which uses the medical record management software, is illustrated in FIG. 1 by its clinic computer system 110. Clinic computer system 110 is a conventional computer system and includes a computer readable data storage system 113, accessed by web server computer 116 and client computer 118. The computers 116 and 118 are typically personal computers, and include software and hardware, understood by those of skill in the art, necessary for using the Internet and running the medical records management software 112 described herein. Computer 116 and 118 are, for example, Pentium or Pentium II (Intel) based personal computers running MicroSoft Corporation's Windows (98 for computer 116 and 95, 98, 2000, or NT for computer 118). Computer 116 also uses, for example, MicroSoft's Personal Web Server (PWS) 4.0 and IIS (4.0). Computer 118 is equipped with a browser, for instance Internet Explorer 4.0 or above or Netscape Communication's Navigator 4.0 or above. The clinic computer system 110 and referral network web site 120 are linked via a global-area network, e.g. the Internet 130.

The computer readable data storage system 113 holds a conventionally organized database of patient contact information 114 and a conventionally organized database of patient medical information 115, as well as other information necessary for managing the clinic through the medical records management software 112. MicroSoft Corporation's MSAccess 2000 Run Time is an example of a database program that can be used with data storage system 114.

The medical records management software 112 is used to create, organize, and access the databases on data storage system 1113. An example of such medical records management software system, the PhysicianSuite™ software, is described at the web site of iMedica Corporation (iMedica.com). Using the medical records management software 112, an electronic version of the medical record is generated and stored in data storage system 113 without using handwritten notes. An electronic charting system in which, for instance, a pen-based, wireless hand-held computer executes the medical records management software is used in place of handwritten notes. The medical records management software 112 lets the physician or assistant chose from a menu of selections in fields such as test results, diagnoses (e.g., current ICD-9CM diagnoses codes), prescriptions, etc., to generate a patient medical record. The software is capable of adapting to the process preferences of the physician and allows, for instance, procedure notes and patient questionnaires to be customized. The generated patient medical record is automatically stored in the databases of data storage system 113 by the medical records management software 112. The medical records management software 112 may also include capabilities for generating bills, writing prescriptions, checking prescriptions against the patient medical record to alert the physician to any drug conflicts, and managing clinic supplies. Some of the additional capabilities of the medical record management software are described in commonly assigned U.S. patent application Ser. No. 09/713,931, “Method and Apparatus for Marketing Pharmaceutical and Medical Products” filed on Nov. 16, 2000 and U.S. patent application Ser. No. 09/714,353, “System and Method for Inventory Control and Ordering Medical Supplies,” filed Nov. 16, 2000 both incorporated herein by reference in their entirety.

As described in more detail below, the referral network software 123 uses the medical record management software 112 to facilitate creating the patient referral letter. Much of the information necessary for the referral letter is automatically entered and stored into databases 125 and 127 from databases 114 and 115 by the referral network software.

The second type of clinic 140 does not use the medical records management software 112. Computer 142, also equipped with a conventional web browser, is used to access the referral network web site via the Internet 130. Without the medical records management software 112, the information necessary to create a patient referral letter is entered by a person for storage into database 125 and 127. This is also the situation when referral network members, who are from clinics which use the medical records management software 112, access the referral network web site from computers not connected to the clinic computer system, for example from a home computer. The computer accessing the referral network must be able to access the clinic data storage system 113 for the referral network software 123 to automatically use the information stored in databases 125 and 127.

Physicians or health-care professionals from either type of clinic may be members of the referral network. To become a member of the referral network, the user accesses the referral network web site (using the Internet) and registers with the referral network, by submitting identifying information and credentials using an online application form. The information submitted is verified by the referral network system administrator. Each referral network member is provided with an account at the referral network web site 120 and the member's contact information is stored in database 126. A fee may be charged to the user to become a member of the referral network.

To create a referral letter with the referral network software 123, a member logs into his or her account on the referral network web site. Typically, the accounts are password protected in the conventional manner. With the referral network software 123, the process of creating a referral letter is highly automated and therefore much less time consuming than traditional methods of writing a referral letter. As described in more detail below, the referral network software 123 accesses the associated databases of patient and physician information stored in data storage system 124 when creating the referral letter. If the referral network member is accessing the referral network from a clinic that uses the medical records management software 112, the referral network software will access databases 114 and 115 when creating the referral letter. This makes it relatively easy for physicians and health-care professional to include relevant information from the patient medical record in the referral letter.

The referral letter is communicated to its intended recipient (the physician to whom the patient is being referred) using the referral network system 100. This can be accomplished in two different ways, depending on whether or not the intended recipient is registered as a member of the referral network.

The case where the intended recipient is a registered member of the referral network system is illustrated in FIG. 2. A referral letter generated by the referring physician at clinic A 210 is stored in data storage system 124 at web site 120. When the referral letter is complete at the referral network web site, the web site referral network software notifies at 204 the intended recipient of the letter (at clinic B 220) in two ways. A notice is sent to the user's referral network account on the referral network web site, for instance on the “welcome” page described below, and a notice is also sent to the user by an Internet e-mail. The e-mail address is listed by the registered physician with his or her contact information, and can be for instance an e-mail address at the clinic or an e-mail address with an Internet Service Provider account. The intended recipient at clinic B 220 then logs into the referral network at 212, through his or her account, and is able to view and/or download the referral letter from the referral network web site.

It should be noted that the security of the medical records transmitted through the Internet and stored in the data storage systems can be protected as described in commonly assigned U.S. patent application Ser. No. 09/571,076, “Medical Records Data Security System,” incorporated herein by reference.

FIG. 3 illustrates the case where the intended recipient is not a registered member of the referral network, for instance a physician at clinic C 310. In this case, the referral network software sends a referral document directly to the physician via conventional facsimile 312. (The recipient's facsimile telephone number, of course, must be known.) In another embodiment, the referral letter is printed on paper for sending by conventional mail or delivery service. In addition to a referral letter, the facsimile (or printed copy) referral document will include a cover sheet or cover letter that contains a promotion describing the benefits of becoming a member of the referral network and of using the referral network software. The promotion is intended to induce the referral letter recipient at Clinic C to use the Internet to visit at 316 the referral network web site 120, and become a member of the referral network by registering with the network, as described above. The promotion is also intended to induce referral letter recipients at Clinic C to license or purchase products associated with the referral network, such as the medical records management software described above.

FIG. 4 is an example of such a cover containing an exemplary promotion for the referral network. In this example, the conventional information 405 used for identifying the facsimile sender and recipient is at the top of the cover sheet. At the bottom of the cover the benefits of the referral network are explained in the promotion 407. This promotion informs the recipient that the referral letter was generated using the referral network software, and can also include a description of the benefits of using the referral network, e.g. time and cost savings, organization of electronic records, rapid communication between physicians and other benefits. The promotion may also include the address, for instance the URL, of the referral network web site, e.g., iMedica.com, as well as information on becoming a member of the web site, and the additional advantages of using the referral network system. The promotion may also include advertisements for other products, such as the medical records management software associated with the referral network and may include, for example, a description of the benefits of using the medical records management software.

The layout of the cover and promotion can be varied in a number of ways. Likewise, the content of the promotion can be varied. In one embodiment, the content of the promotion is changed from time to time, for instance to highlight different advantages of the referral network or associated medical records management software, each time a referral letter is faxed (or sent) to a recipient physician.

This physician-to-physician marketing using the referral letter is a useful aspect of the referral network, as it allows advertisement of the network and associated products to be targeted directly to potential members of the network from trusted members of their own profession. It also allows potential members of the referral network to see directly the product (the referral letter) of the referral network software. Because a single physician using the referral network will send out many referral letters to a number of different physicians, and these physicians will, in turn, each send out a many referral letters, this physician-to-physician marketing tool has to power to quickly reach numerous potential customers. Thus the referral network software can be thought of as a “viral” (rapidly spreading) marketing vehicle.

One of the inducements for becoming a member of the referral network is the ease with which the recipient physician can provide the referring physician response information regarding the patient. The referral network software used to generate the referral letter referring a patient to a physician can be used in a similar way, as described in more detail below, to generate a physician response letter. The physician response letter can be communicated to the referring physician using the referral network system in the same way the original referral letter was communicated.

If the participating clinics, 210 and 220, also use the associated medical records management software, each referral letter, including physician response letters, sent for a particular patient becomes a part of that patient's medical record and is stored in the clinic data storage system 113. The data used to create the referral letter to display to a user over the Internet, described in more detail below, is stored at the referral network web site 120. This provides an accurate medical record for the patient, that members of the referral network can access.

One embodiment of the referral network software used to generate referral letters, including physician response letters, is now described with reference to FIGS. 5-12. In this embodiment, the programs of the referral network software are coded using the computer languages/technologies HTML, VBScript, JScript, and Javascript, and are used with a web browser. Writing the referral network software would be routine to one of ordinary skill in the art in light of this disclosure. The referral network software is written using Active Server Pages (ASP). Active Server Pages are part of MicroSoft Corporation's Internet Information Server and Personal Web Server. Active Server Pages are not compiled, but are run-time interpreted by the web server during a user's Internet session. The Active Server Pages output HTML pages displayable by an Internet browser. The programs of the referral network software are provided in the Appendix. The names of the particular Active Server Page programs used for each of the FIGS. 5-12 are listed in the following table:

| | Active server page program |
|---|---|
| Figures | (found in Appendix A) |
| | welcome.asp |
| | new_letter.asp |
| | patient.asp |
| | new_letter.asp |
| | select_visit.asp |
| | chart.asp |
| | comp_main.asp |
| | editframe.asp |
| | prevu_t*.asp (*depends on template chosen) |
| | sendOrdraft.asp |

For referral network members accessing the referral network from clinics that use the medical records management software 112, some of the Active Server Pages reside on the clinic computer system server 116 and are used to access the patient information from the databases 114 and 115. The other Active Server Pages of the referral network software reside on the referral network web site server computer 122 and are used to carry out the other functions of the referral network software, such as administration. The referral network software intelligently calls upon the Active Server Pages residing on either the clinic computer system 110 or web site computer system 120 depending on the functionality required.

If the referral network user does not also use the medical records management software 112, the Active Server Pages residing on clinic computer system server 116 are not used and instead information is entered by hand.

As described above, a referral network member will have an account with the referral network system that allows him or her to generate and send referral letters using the system. In addition to member accounts, the system provides for administrative accounts, which can be set up from the member accounts. Administrative accounts can be used to generate referral letters but not to send referral letters. The administrative accounts are typically for use by health-care workers associated with a physician, such as nurses and physician's assistants. In the administrative account, the associated health-care worker can prepare a draft of a referral letter for the physician. The physician then only needs to check the draft of the referral letter before it is sent, thus saving the physician time. The member account user, the physician, gives the administrative account user a password. The password cannot be changed in the administrative account. Also, the profile information, discussed below, of the member account user cannot be changed in the administrative account.

FIG. 5 shows the “welcome” page displayed to a user on his or her computer after the user has logged into the referral network web site computer system 120. The “welcome” page provides the user with account status, information about the referral network system, and choices for proceeding with the referral network. A central information box 510 displays information about referral letters currently stored in the system. For example, the number of referral letters the user has received 512 or the number of referral letters the user has started to compose but has not sent 514. Both of these messages provide conventional hyperlinks to additional pages that provide access to the stored messages.

A physician may practice in more than one clinic. If those clinics use the associated medical records management software, the referral network software will need to access data storage systems containing patient medical records, such as data storage system 113, at the different clinics to create referral letters for different patients at those clinics. In the example of FIG. 5, the text in the lower half of box 510 refers to an “iMedica PhysicianSuite user” and the “PSManager database”. An “iMedicaPhysicianSuite user” is a referral network member whose clinic uses the medical records management software to enter data into data storage system 113. The “PSManager database” refers to the databases on data storage system 113. Hyperlink 520, when selected will take the user to a page that allows the clinic from which patient information will be retrieved to be selected from a list of clinics at which the physician practices. Changing the clinic selected causes the referral network software to access the database of patient information from the database of the specified clinic.

If the user is accessing the referral network from a clinic that uses the medical records management software, the “Setup Clinic” button 521, when selected, takes the user to the “Clinic Info” page. This page allows the user to configure the various clinics at which she or he practices. This is accomplished by listing the clinic_id of the clinic computer system 110 and the server name of the computer 118. The configuration will provide information necessary for the referral network software to access the appropriate database of patient information when the clinic is chosen, for instance, by using hyperlink 520. Additionally, for a physician that practices at more than one clinic, the physician's contact information will change for each clinic. Thus, the clinic-related contact information needed as part of the referral letter, can be entered on this page. Once entered, the clinic-related contact information is used for all subsequent referral letters.

Across the top of FIG. 5 is a row of hyperlinks to various modules of the referral network software. These hyperlinks take the user to pages that provide access to stored messages and which function in a manner similar to the routine messaging of e-mail software. The “Inbox” hyperlink 542 when selected will take the user to the same page as hyperlink 512, from which the user can access referral letters that have been received. Likewise the “Draft Letters” hyperlink 546 when selected will take the user to the same page as hyperlink 514, from which the user can access and manipulate drafts of referral letters which have not yet been sent. To view referral letters that have been sent, the user selects the “Sent Items” hyperlink 544. A “Deleted Items” hyperlink 548 when selected takes the user to a conventional delete mode page where referral letters can be deleted completely from the system, restored to the system (un-deleted), sorted or printed.

The “New Letter” hyperlink 550 when selected takes the user to pages of the “Compose” module, which are used to automatically generate referral letters, as discussed below in reference to FIGS. 6-12.

The column on the left side of FIG. 5 is a list of hyperlinks to pages related to the organization and management of the information used by the referral network software. “Change Password” 561 is a hyperlink to a conventional change password module. This link is not available to administrative account users. Administrative account user passwords can only be set and changed by the member account user. The “Change Profile” hyperlink 562, when selected allows the user to change his or her contact information stored in database 126 and also to set up or delete administrative accounts. The “Change Profile” hyperlink 562 is not available in administrative accounts. The “Clinic Info” hyperlink 563 takes the user to the same “Clinic Info” page as the “Setup Clinic” button 520, which was discussed above.

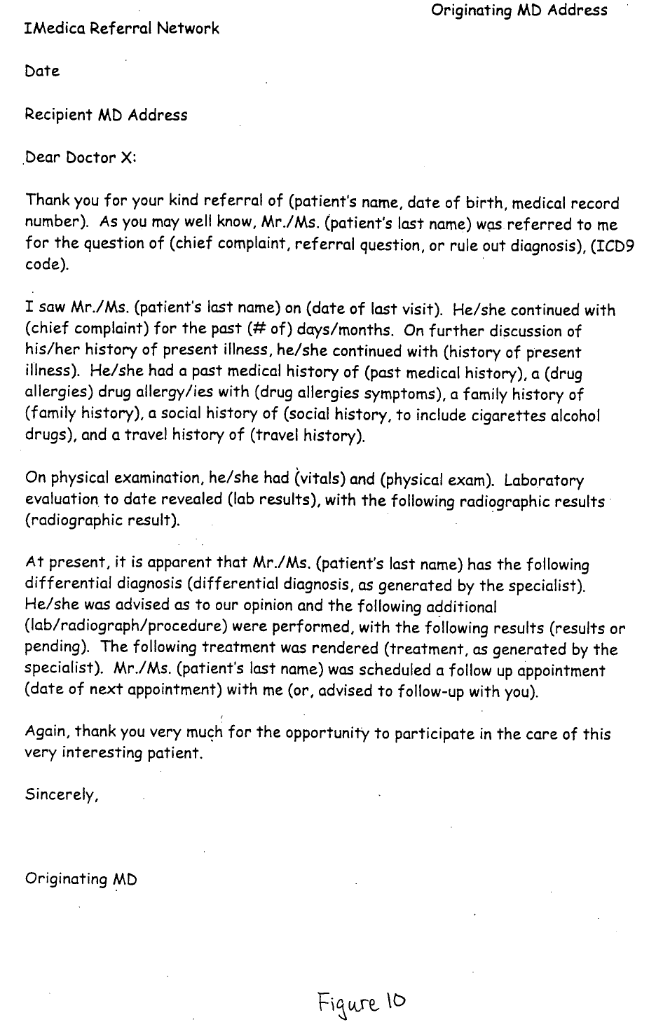

The “Submit Template” link 564 is used in conjunction with the “Compose” module and allows the user to enter and alter various template formats for the final form of the referral letter, described below in reference to FIG. 10. The “Edit Template List” link 574 allows the user to change the names of the various templates from the default names of “template 1” and “template 2” to any user-created name.

The “Physician Info” 565 and “Patient Info” 566 hyperlinks provide access, respectively, to the database of physician contact information 126, including the referring and recipient physicians, and the database of patient contact information 125. Both databases are stored in data storage system 124. Patient contact information includes the patient name, address, telephone number and other information used to identify and communicate with the patient. Physician contact information can include the physician's name, address, e-mail, phone numbers and other information used to communicate with the physician, and can also include the physician's area of specialization and other professional information.

The physician contact information for the member physician sending the referral letter is entered into database 126 when the physician initially registers with the referral network and can be accessed for alteration using the “Physician Info” hyperlink 565. The physician contact information for the physician who will receive the referral letter must be explicitly entered into the database, again using the “Physician Info” hyperlink 565, the first time that physician's contact information is used. For patient contact information, if the referral network user is accessing the referral network from a clinic that uses the medical records management software, the patient contact information is transmitted from the clinic database 114 to web site database 125. This transmission occurs when the referral letter is composed using the “Compose” module described below. Patient contact information already in the database is accessed via the “Patient Info” hyperlink 566. If the user's clinic does not use the medical records management software, the patient contact information is entered by hand through online forms accessed via the “Patient Info” hyperlink 566.

Additional useful features may be added to the referral network software, for instance, the calendar link 567, which can be used to facilitate scheduling.

There is also a conventional “Home” hyperlink 570 returning the user to the “welcome” page from any module. A conventional “Help” hyperlink 571 takes users to a web page with written instructions for using the referral network. The “Support” hyperlink 572 will connect the user to a page with information on contacting the referral network technical support, and a text area in which the user can enter and submit (via e-mail) questions to the referral network technical support personnel. The conventional “Log Off” hyperlink 573 will exit the user from the program.

Displayed on the lower half of the “welcome” page is a description of how to use the site, with duplicate hyperlinks to the hyperlinks listed across the top of the “welcome” page. These duplicate hyperlinks help the user, particularly a new user, navigate the site. For example, the “Create a new referral letter” link 580 takes the user to the same page as the “New Letter” link 550, the “Edit an unfinished referral letter” link 586 is identical to the “Draft Letters” link 546, and “View the referral letters previously completed by you” link 584 is identical to link 544. The “Recover letters” links 588 and 598 take the user to the same page as “Deleted Items” link 548. The “View the referral letters sent to you by other physicians” link 592 takes the user to the “Inbox” page as would link 542.

FIG. 6 is an example of the first web page of the “Compose” module, which is accessed via, for example, the “New Letter” hyperlink 550 on the “welcome” page. The first page of the “Compose” module is used to insert two sets of information into the referral letter: the patient contact information 610 and the physician contact information 620 for the physician to whom the patient is being referred. Both sets of information are selected from information already stored in the databases 125 and 126 using conventional select/search fields, 612 and 622.

If the necessary patient or physician contact information is not in the database or is incorrect as stored in the database and needs to be altered, the hyperlinks 614 and 624 when selected can take the user to a page for entering data into to the databases by hand. FIG. 7 illustrates an example of such a web page for patient information, obtained after using hyperlink 614. This page shows a patient's name and conventional contact information fields that can be altered. Note that the page illustrated in FIG. 7 can also be reached from hyperlink 566, described above. The correct contact information is then stored in the database of patient contact information 125 on data storage system 124. A similar web page is used to change the physician contact information.

If the user is accessing the referral network web site from a clinic that uses the medical records management software, the “Look-Up from PSManager Database” button 616, FIG. 6, when selected allows the user to select patient contact information from the clinic database 114 for transmission to the referral network database 125. Patient contact information added to the database 125 from database 114 cannot be altered at the referral network web site, but must be altered in database 114. Database 114 serves as the master copy of the patient information. Similarly, the physician contact information of physicians who use the medical records management software cannot be altered at the referral network web site but must be altered using the medical records management software 112 at the clinic computer system 110.

The “NEXT” button 630 is a hyperlink to the next page of the “Compose” module. The “RESET” button 640 conventionally cancels any selected patient and physician contact information in fields 612 and 622, respectively.

FIG. 8A displays the web page in the “Compose” module obtained when “NEXT” button 630 is selected. This page displays, for verification purposes, the patient contact information 810 and physician contact information 820 chosen on the previous page, FIG. 6, to be used in the referral letter. The “Back to Re-Select” button 830, when selected, allows the user to return to the previous page and to select new patient and physician contact information. When the patient and physician contact information are selected, the referral network software will check to see if there is a draft letter already in progress for the selected patient and physician. If a corresponding draft letter is found, the user may access the draft letter using the “Work on it” hyperlink 860.

If the user is accessing the referral network from a clinic that also uses the medical record management software, the “Select a chart note from database” button 840 will allow the user to select medical information from the patient's medical record for automatic entry into the fields in the “Referral Letter Composer” page, which is discussed below in FIGS. 9A and 9B. The patient medical record is composed of chart notes recorded by the physician using the medical records management software 112. The chart notes are stored in the patient medical information database 115. When button 840 is selected, the user is taken to the page illustrated in FIG. 8B, which displays chart notes 841 that have been recorded for the selected patient. In the example of FIG. 8B only one chart note 841, recorded on date Nov. 29, 2000, is shown. The date hyperlink 843 can be used to view the particular chart note, such as the chart note illustrated in FIGS. 8C and 8D. To select information from a particular chart note for inclusion in the referral letter, the user identifies the desired chart note using button 845, and selects the identified note using button 847. The patient medical information is transmitted to database 127 from database 115 and the medical record fields, shown in FIGS. 9A and 9B, used to create the referral letter are automatically filled. This feature saves time for the physician.

The “Start New Letter” button 850 when selected takes the user directly to the “Referral Letter Composer” page of the “Compose” module.

The “Referral Letter Composer” page, illustrated in FIGS. 9A and 9B, allows information from the patient medical record and other referral letter content to be entered and selected for creation of the referral letter. The contents of a referral letter that change from letter to letter have been identified and broken down into different fields 901. Therefore, the body of the web page displays text boxes 902 that allow the user to select the fields necessary for describing the patient condition to the physician to whom the patient is being referred. The fields are either populated by selection of the chart note, described above, or filled in by the user. Fields that were automatically filled using the “Select a chart note from database” feature 840 are stored in database 127 and cannot be altered, to preserve database 115 as the original, “master” copy. These fields are typically indicated by using a different color for the field label than is used for the labels of the alterable fields. If the “Select a chart note from database” feature is not available to the user (i.e., the user does not use the medical records management software 112), the fields may be filled in by typing the information directly into the text boxes 902. For example, information on the patient's family history can be entered into the family history field by typing the information into box 915. Information entered in this manner will be stored and alterable in database 127.

The user creates the letter by selecting the fields corresponding to the content the user would like in the letter. Next to each field, is a check box 920, so that fields that are not applicable can be de-selected and excluded from the body of the referral letter. The fields are then used in conjunction with a letter template to render a complete letter for viewing.

At the bottom of the page the user can, at any time, preview what the actual referral letter will look like using one of the available templates by clicking on a template name 910 in template list box 912. When the template button is used, the referral network software inserts the chosen fields into the correct sections of the chosen letter template, and takes the user to a new page showing the complete letter. Only fields with selected check boxes 920 are incorporated into the template. FIG. 10 is an example of a letter template that may be used with the referral network software.

The template feature is one of the advantages of the referral network software as it allows a wide variety of letters to be produced and gives the program flexibility so that it will work in many different clinic settings. For instance, the templates can be configured to provide either a referral letter or a response letter to the referring physician. The example shown in FIG. 10 is a response letter. Each user or clinic can submit templates to the referral network via fax or over the Internet and the templates are added to that user's account. The “submit template” hyperlink 564 allows templates to be added or changed.

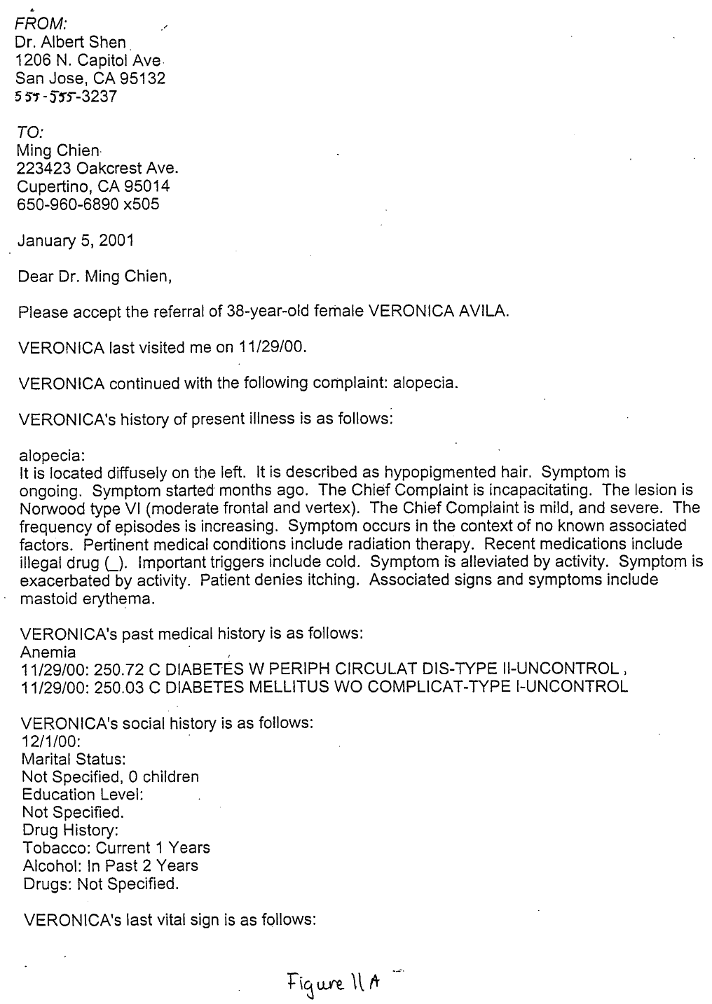

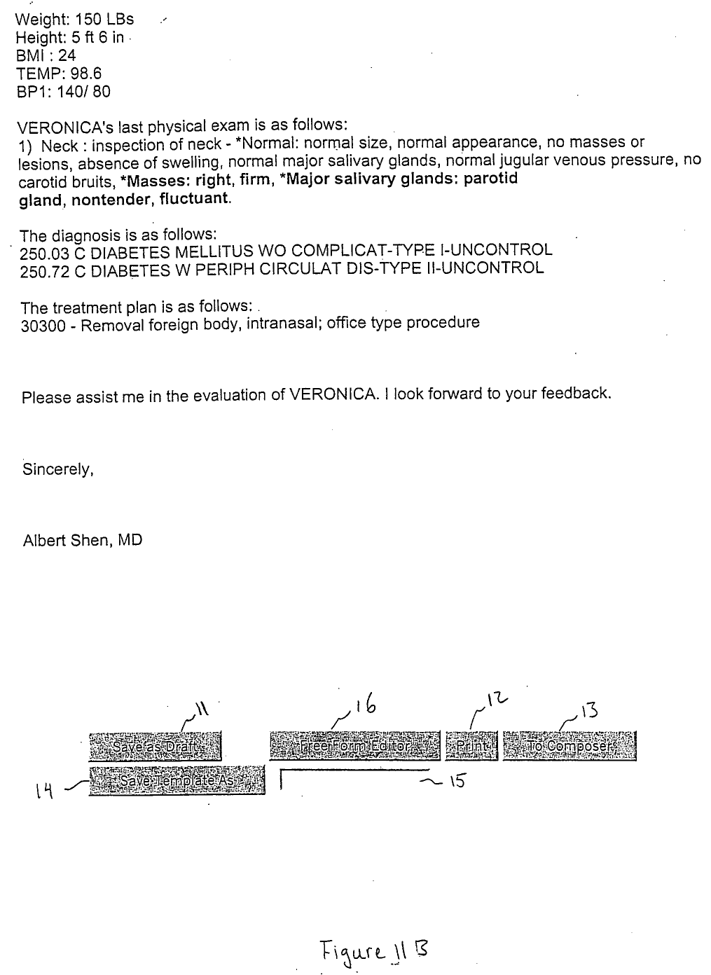

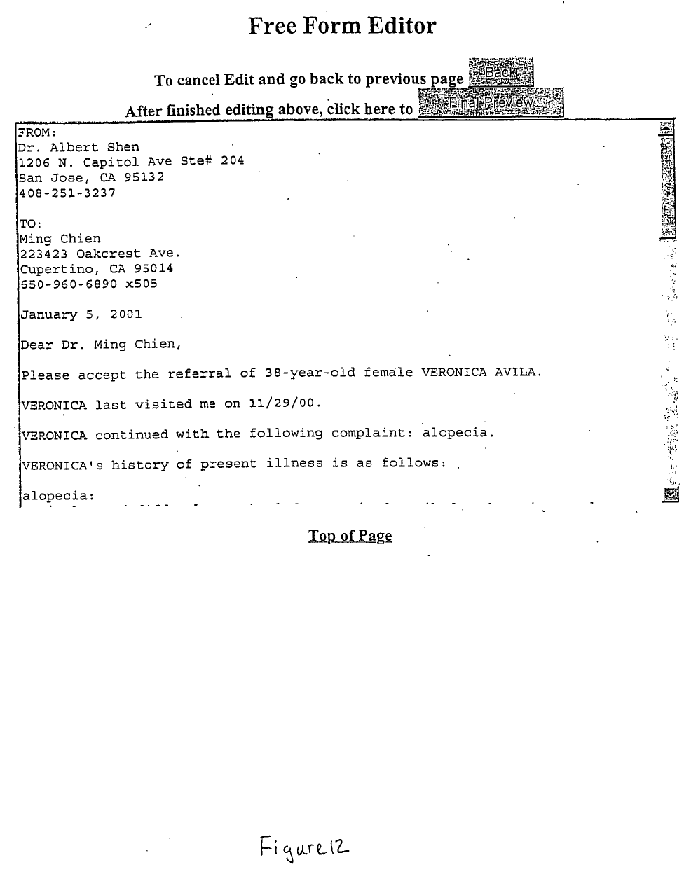

From the “Referral Letter Composer” page, FIGS. 9A and 9B, the completed referral letter can be previewed by selecting a template 910 from the list of templates in box 912. This links the user to a preview page showing the completed letter, an example of which is shown in FIGS. 11A and 11B. At the bottom of the preview page are buttons that allow the user to save the completed letter as a draft, button 11, print the letter, button 12, return to the “Referral Letter Composer” page, button 13. The “Save Template As” button 14 and text field 15 allow the user to change the name of the template. The “Free Form Editor” button 16 takes the user to a text editor page, shown in FIG. 12, that allows the user to edit any of the text of the letter before it is saved as a draft for sending.

If the physician to receive the referral letter is not a member of the referral network system, the referral document can be faxed or mailed to that physician. Typically, if the referral document is generated at a clinic that uses the medical records management software 112, the referral network software will fax the letter as viewed on the “Compose” page and include the cover promoting the referral network. Alternatively, if the referral letter is generated at a clinic that does not use the medical records management software, the letter and cover are printed and sent by post. If the referral letter is to be sent to a physician who is a member of the referral network, the information in the filled in fields and the type of template chosen are stored in the data storage system 124. When a member physician wishes to view the letter, referral network software 123 in the web site 120 renders the letter from the information previously stored in the databases.

This description is illustrative and not limiting; further modifications will be apparent to one skilled in the art in light of this disclosure and are intended to fall within the scope of the appended claims.

What is claimed is:

1. A method for creating a referral network of physicians comprising the acts of:
registering at least one physician;
generating a patient referral document from said registered physician, said document including a promotion for said referral network; and
sending said referral document to a second physician.

2. The method of claim 1 wherein said promotion induces said second physician to register with said referral network.

3. The method of claim 1 wherein said patient referral document comprises a patient referral letter and a cover.

4. The method of claim 3 wherein said cover carries said promotion.

5. The method of claim 3 wherein said patient referral letter comprises patient medical information, patient contact information, and physician contact information.

6. The method of claim 3 wherein said patient referral letter is in response to a prior referral, said prior referral letter sent to said second physician by said registered physician.

7. The method of claim 1 further comprising providing a computer system, said computer system comprising a server hosting a web site for said referral network.

8. The method of claim 7 wherein said promotion includes the URL of said web site.

9. The method of claim 7 wherein said computer system further comprises a data storage system storing a database of patient contact information, a database of physician contact information, and a database of patient medical records

10. The method of claim 9 wherein said physicians who are registered with said referral network can access said data storage system on said computer system.

11. The method of claim 1 wherein the act of generating a patient referral document comprises:
selecting particular patient contact information from a database of patient contact information;
selecting particular physician contact information from a database of physician contact information;
selecting particular patient medical information from a database of patient medical records;
selecting a letter template;
inserting said patient contact information, physician contact information, and patient medical information into said letter template to form a patient referral letter; and
generating a cover including said promotion

12. The method of claim 1 wherein said referral document is generated by a person associated with said registered physician and wherein said referral letter is sent by said registered physician.

13. The method of claim 1 wherein said at least one physician pays a fee to register.

14. A system for creating a referral network of physicians, said system comprising:
a server computer;
a data storage system associated with said server computer, said data storage system storing a database of physician contact information, a database of patient contact information, and a database of patient medical records;
a computer program executed by said server computer, said computer program comprising instructions for providing physician accounts on said server computer, said computer program further comprising instructions for;
selecting patient contact information from said database of patient contact information;
selecting physician contact information from said database of physician contact information;
selecting patient medical information from said database of patient medical records;
selecting a referral letter template;
inserting said patient contact information, physician contact information, and patient medical information into said referral letter template to form a referral letter;
generating a cover including a promotion for said referral network; and
sending said referral letter and cover to a second physician.

15. The system of claim 14 wherein said referral letter and cover are sent via facsimile.

16. The system of claim 15 wherein said promotion induces said second physician to join said referral network.

17. The system of claim 15 wherein said promotion induces said second physician to register with said referral network via said server computer.

18. The system of claim 14 further comprising:
a second computer communicating with said server computer through a global-area network; and
a second data storage system associated with said second computer, said second data storage system storing a second database of patient contact information and a second database of patient medical records;
wherein said computer program further comprises instructions for;
selecting patient contact information from said second database of patient contact information and transmitting said selected patient contact information from said second computer to said data storage system associated with said server computer; and
selecting patient medical information from said second database of patient medical information and transmitting said selected patient medical information from said clinic computer to said data storage system associated with said server computer.

19. The system of claim 18 wherein a computer program executed by said second computer generates said second database of patient medical information and said second database of patient contact information.

20. A computer generated file comprising:
a patient referral document from a first physician to a second physician; and
an associated cover document for said patient referral document and including a promotional announcement to join a physician referral network; j
wherein said patient referral document is a merged document including a template and patient specific data.
